(19) United States
(12) Patent Application Publication
(10) Pub. No.: US 2002/0185767 A1
(43) Pub. Date: Dec. 12, 2002

(54) Method and apparatus for thermoforming fiber packaging

(75) Inventor: Martin J. Barker, Newbold Rochdale (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: PX Industries Incoporated

(21) Appl. No.: 09/879,755

(22) Filed: Jun. 12, 2001

(51) Int. Cl. B29C 35/08; B29C 51/42; B29C 51/46

(52) U.S. Cl. 264/40.6; 264/479; 264/486; 264/491; 425/385; 425/384; 425/174

(57) ABSTRACT

An apparatus for thermoforming an article of fiber packaging from a fibrous slurry is provided. The apparatus includes first and second co-operable dies being adapted to receive the fibrous slurry therebetween. The apparatus includes at least one thermal mass mounted to at least one of the first and second dies. The apparatus includes at least one radio-frequency induction coil mounted to at least one of the first and second dies. The apparatus includes a power source in electrical communication with the at least one radio-frequency induction coil to supply radio-frequency energy thereto and wherein the coil is adapted to induce an electromagnetic field within one or more thermal masses to heat a respective die and thermoform the fibrous slurry into the article of fiber packaging. At least one of the first and second dies can include at least one sensor for measuring the temperature of the respective die.

### FIELD OF THE INVENTION

The present invention relates to fiber packaging, and, more particularly, relates to a method and apparatus for thermoforming fiber packaging.

### BACKGROUND OF THE INVENTION

Fiber packaging, which can be formed in many different configurations, is used extensively to package, ship and store a variety of products, including food products, personal care items, and electronic equipment and components, among others. Fiber packaging is typically formed by pressing a wet fibrous slurry between shaped dies in a forming machine to compress, mold and dry the slurry into the desired configuration. As illustrated in FIG. 1, conventional forming machines 10 generally include one or more preforming or de-watering stations 12 that press the fibrous slurry into a preform, one or more pressing or drying stations 14 that complete the forming process by further consolidating and drying the preform, and one or more conveying stations 16 for transporting the fiber packaging away from the forming machine. Alternatively, a conventional forming machine can include one or more combined de-watering and drying stations. As such, the wording “fibrous slurry” or “slurry,” as used herein, is intended to include both a wet fibrous slurry and a fibrous preform.

As illustrated in FIG. 2, the dies 18 of a conventional forming machine 10 that are used to dry the fibrous slurry 20 are typically mounted on respective steel heating plates 22, which conduct heat through the dies to the slurry pressed therebetween to thereby dry the slurry. The heating plates can be heated by channeling hot steam through the heating plates or by an electric heater embedded within the heating plates. Alternatively, according to the forming machine 10 illustrated in FIG. 2, the heating plates 22 are heated by induction coils 24 sandwiched between the two steel plates 22a, b forming each heating plate 22. Power is supplied to the induction coils through an electrical power source (not shown). For example, in one embodiment, the power source is a 28.8 kW power source that supplies approximately 415 V three-phase power at between about 50 to 60 Hz to the induction coils to preheat the heating plates 22 to approximately 200 to 300° C.

Conventional forming machines, such as the one illustrated in FIG. 2, have many disadvantages. Due to thermal resistance and heat loss associated with conducting heat from the heating plates 22 through the dies 18 to the fibrous slurry 20, conventional forming machines generally have a maximum efficiency of between 45 and 60 percent. This relatively low efficiency results in the dies 18 being starved of heat, thus, increasing the cycle time necessary to heat and dry the fibrous slurry 20 pressed between the dies. Additionally, because the induction coils 24 of conventional forming machines are positioned within the interior of the heating plates 22, servicing and/or replacement of the coils can be time and labor intensive, which can increase the operating cost of the machine and result in undesirable down time.

In seeking better apparatus for forming fiber packaging, several other types of forming machines have been developed. One such example of a forming machine is disclosed in U.S. Pat. No. 5,641,449 to Owens, which discloses a forming machine in which a preformed cold-pressed wet fiber mat is compacted as radiowave energy and surface heat are simultaneously transmitted and applied, respectively, to the mat to dry the mat. The radiowave energy transmitted to the wet fiber mat includes either low-radio-frequency (“LRF”) waves having a frequency between about 10 kHz to approximately several hundred megahertz or microwaves having a frequency between approximately several hundred megahertz to 30 GHz. In one embodiment, the wet fiber mat is mounted onto a mold insert and then sandwiched between a top press plate and a bottom support plate. An LRF voltage is then applied directly to the top and bottom plates, which energy is transmitted by the plates to the wet fiber mat to dry the interior regions of the mat. In another embodiment, the wet fiber mat is mounted onto a mold insert and then pressed between the insert and a top mold or plate as microwave energy is transmitted to the mat through the mold insert. The mat is encased within a relatively complex and expensive enclosure in order to contain the microwave energy and avoid hazardous irradiation of nearby personnel and interference with electronic equipment. As disclosed in the '449 patent, the transmitted radiowave energy penetrates the interior of the wet fiber mat such that the '449 forming machine is particularly suited for forming sculptured fiberboard products that are thicker than approximately one-half inch.

Simultaneously with the transmission of microwave or LRF energy to the interior of the mat, the top and bottom plates of the '449 forming machines are heated so as to conduct heat to the surface of the mat. The plates are heated by circulating heated steam through channels defined within the plates, using embedded electric heaters, or using a natural gas oven between drying runs to create a thermal mass to passively heat the wet mat. However, as with other conventional forming machines, the cycle time of the plates of the '449 forming machines is impeded by thermal resistance and heat loss associated with conducting heat from the hot steam, embedded electric heaters, or natural gas oven to the plates and then to the wet fiber mat. The low cycle time decreases the output of the machines and increases energy consumption, thus, increasing overall operating costs.

In light of the foregoing, there remains a need for an improved forming apparatus and associated method of thermoforming fiber packaging. Such a forming apparatus should be capable of quickly and efficiently heating and drying a fibrous slurry to thereby reduce the cycle time and increase the output of the forming apparatus. In addition, the forming apparatus should be capable of being economically operated, maintained and serviced.

### SUMMARY OF THE INVENTION

The present invention provides an apparatus and associated method of manufacture for thermoforming an article of fiber packaging from a fibrous slurry in which the slurry is heated and dried between two forming dies by heating the dies using one or more radio-frequency induction coils mounted thereto. Each radio-frequency induction coil quickly and efficiently heats the respective die by inducing an electromagnetic field in one or more thermal masses mounted to the respective die to thereby reduce the cycle time and increase the output of the forming apparatus. Additionally, the radio-frequency induction coils can be prepackaged so that the apparatus can be economically operated, maintained and serviced.

More particularly, the apparatus includes first and second co-operable dies being adapted to receive the fibrous slurry therebetween. Each of the first and second dies defines a base and a pair of sides. In one embodiment, the dies are formed of aluminum. In another embodiment, the apparatus includes a member for moving the first die towards and away from the second die. The apparatus includes at least one thermal mass mounted to at least one of the first and second dies. In one embodiment, the thermal mass comprises a steel plate. In another embodiment, at least one thermal mass is mounted to one of the bases of the respective die. In yet another embodiment, at least one thermal mass is mounted to one of the sides of the respective die.

The apparatus includes at least one radio-frequency induction coil mounted to at least one of the first and second dies. In one embodiment, the radio-frequency induction coil includes at least one copper tube and an epoxy shell at least partially encasing the at least one copper tube. In another embodiment, the radio-frequency induction coil is water-cooled. In still another embodiment, at least one radio-frequency induction coil is mounted to one of the bases of the respective die. In yet another embodiment, at least one radio-frequency induction coil is mounted to one of the sides of the respective die.

The apparatus includes at least one power source in electrical communication with the at least one radio-frequency induction coil to supply radio-frequency energy thereto and wherein the coil is advantageously adapted to induce an electromagnetic field within the at least one thermal mass to thereby heat the respective die and thermoform the fibrous slurry into an article of fiber packaging. In one embodiment, the energy source supplies radio-frequency energy at between approximately 90 to 110 kHz. In another embodiment, at least one of the first and second dies includes at least one sensor for measuring the temperature of the respective die and wherein the sensor is in operable communication with the power source for automatically controlling the temperature of the respective die.

In another embodiment, the apparatus includes a forming station and at least one press station. The press station includes first and second co-operable dies being adapted to receive the fibrous slurry therebetween. Each of the first and second dies defines a base and a pair of sides. In one embodiment, the dies are formed of aluminum. In another embodiment, the press station includes a member for moving the first die towards and away from the second die. At least one thermal mass is mounted to at least one of the first and second dies. In one embodiment, the thermal mass comprises a steel plate. In another embodiment, at least one thermal mass is mounted to one of the bases of the respective die. In yet another embodiment, at least one thermal mass is mounted to one of the sides of the respective die.

At least one radio-frequency induction coil is mounted to at least one of the first and second dies of the press station. In one embodiment, the radio-frequency induction coil includes at least one copper tube and an epoxy shell at least partially encasing the at least one copper tube. In another embodiment, the radio-frequency induction coil is water-cooled. In still another embodiment, at least one radio-frequency induction coil is mounted to one of the bases of the respective die. In yet another embodiment, at least one radio-frequency induction coil is mounted to one of the sides of the respective die.

The press station includes at least one power source in electrical communication with the at least one radio-frequency induction coil to supply radio-frequency energy thereto and wherein the coil is advantageously adapted to induce an electromagnetic field within the at least one thermal mass to thereby heat the respective die and thermoform the fibrous slurry into an article of fiber packaging. In one embodiment, the energy source supplies radio-frequency energy at between approximately 90 to 110 kHz. In another embodiment, at least one of the first and second dies includes at least one sensor for measuring the temperature of the respective die and wherein the sensor is in operable communication with the power source for automatically controlling the temperature of the respective die.

The present invention also includes a method of forming an article of fiber packaging from a fibrous slurry, including positioning a layer of slurry between first and second dies. Thereafter, radio-frequency energy is supplied to at least one induction coil mounted to at least one of the first and second dies to thereby heat the respective die and thermoform the fibrous slurry into the article of fiber packaging. In one embodiment, the method includes inducing an electromagnetic field in at least one thermal mass mounted to at least one of the first and second dies and then conducting heat from the at least one thermal mass to the respective die. In another embodiment, the method includes cooling the at least one induction coil with water. In another embodiment, the method includes measuring the temperature of the heated die and then automatically adjusting the radio-frequency energy supplied to the at least one induction coil to thereby modify the temperature of the respective die. In still another embodiment, the method includes moving the first die towards the second die before the supplying step and moving the first die away from the second die after the supplying step.

In yet another embodiment, the method of forming an article of fiber packaging from a fibrous slurry includes positioning a layer of slurry between first and second dies and then inducing an electromagnetic field within at least one thermal mass mounted to at least one of the first and second dies using radio-frequency energy to thereby heat the respective die and thermoform the fibrous slurry into the article of fiber packaging. In one embodiment, the method includes measuring the temperature of the heated die and then automatically adjusting the electromagnetic field within the at least one thermal mass to thereby modify the temperature of the respective die. In another embodiment, the method includes moving the first die towards the second die before the supplying step and moving the first die away from the second die after the supplying step.

Thus, there has been provided an improved forming apparatus and associated method of manufacture that is capable of efficiently heating and drying a fibrous slurry to thereby reduce the cycle time and increase the output of the forming machine. In addition, the improved forming apparatus is capable of being inexpensively operated, maintained and serviced.

### BRIEF DESCRIPTION OF THE DRAWINGS

Some of the objects and advantages of the present invention having been stated, others will appear as the description proceeds when taken in conjunction with the accompanying drawings, which are not necessarily drawn to scale, wherein:

FIG. 1 is an elevational view illustrating a conventional forming machine, as known in the art;

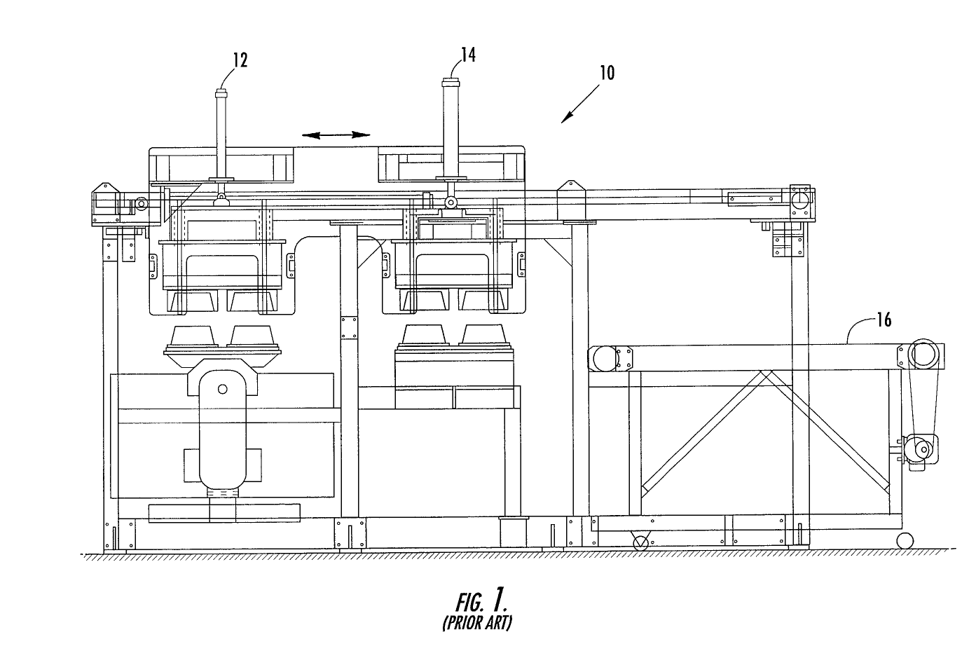

FIG. 2 is a partial cross-sectional view illustrating one embodiment of a conventional forming machine, as known in the art;

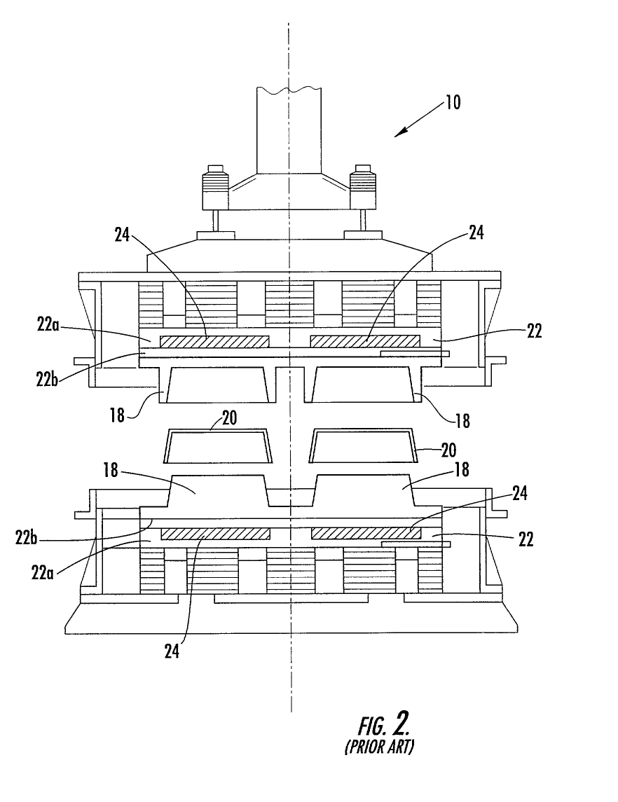

FIG. 3 is a partial cross-sectional view illustrating a forming machine, according to one embodiment of the present invention; and

FIG. 4 is a cross-sectional view illustrating a die of a forming machine, according to another embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

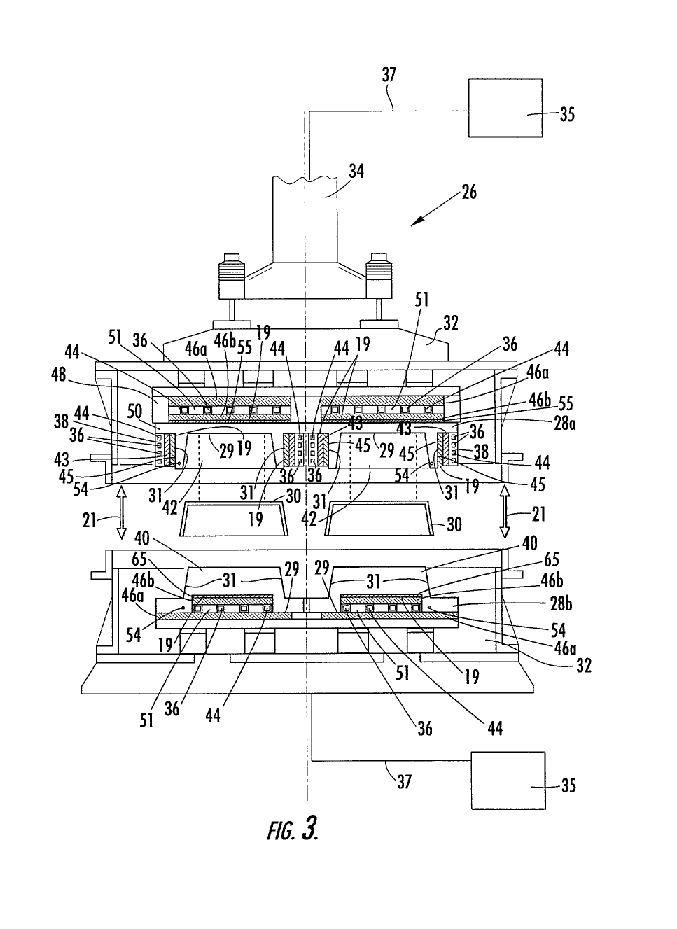

Referring now to the drawings and, in particular, to FIG. 3, there is illustrated an apparatus 26 for thermoforming an article of fiber packaging from a fibrous slurry 30, according to one embodiment of the present invention. The apparatus 26 includes first and second co-operable dies 28a, b, which are adapted to receive the fibrous slurry 30 therebetween. As discussed above, the apparatus 26 can include a combined de-watering and drying station or, alternatively, can include separate de-watering and drying stations in which the drying or press station includes the first and second co-operable dies 28a, b.

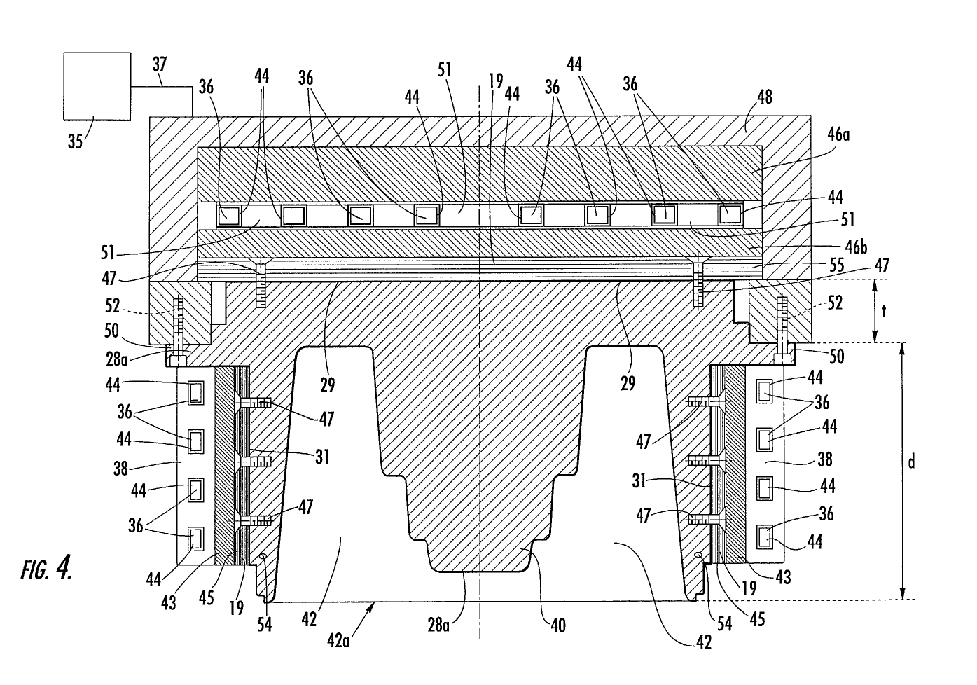

As illustrated by a comparison of FIGS. 3 and 4, the first and second co-operable dies 28a, b can be formed in a variety of different configurations depending upon the desired configuration of the fiber packaging. Each of the first and second dies 28a, b defines a base 29 and a pair of sides 31. The first and second dies are preferably constructed of a material that has high machinability, so that the dies can be machined with the requisite details and tolerances to form fiber packaging having the desired configuration, as well as high thermal conductivity, so that heat generated within the at least one thermal mass 19 is quickly and efficiently conducted through the respective dies to the fiber slurry 30. In one embodiment, the first and second dies 28a, b are formed of a nonferrous metal or alloy such as aluminum or an aluminum alloy. The first and second dies 28a, b can also be formed of brass, beryllium, copper, or bronze. As illustrated in FIG. 3, each of the first and second dies 28a, b can be mounted within a housing 32. For example, the assignee of the present application has developed a press station having a sealable chamber housing, as disclosed in U.S. Pat. No. 6,210,531, which is commonly owned, the entire disclosure of which is hereby incorporated herein by reference. As illustrated by the arrows 21 in FIG. 3, the apparatus preferably includes a member 34 for moving the first die 28a towards and away from the second die 28b. The member 34 can comprise a ram actuated by a hydraulic or pneumatic pump (not shown). The movement of the dies 28a, b relative to one another can be manually controlled, but preferably is automatically controlled by a controller (not shown), such as a computer or microprocessor, operating under software control to enable high-speed mass production of the fiber packaging.

The apparatus 26 includes one or more thermal masses 19 mounted to at least one of the first and second dies 28a, b. Advantageously, the one or more thermal masses 19 conduct heat to the respective die 28a, b to thereby quickly and efficiently heat the die and thermoform the fibrous slurry 30 into an article of fiber packaging. Each thermal mass 19 is preferably formed of a ferrous metal or alloy, such as mild steel, and can have a variety of configurations. For example, as illustrated in FIG. 3, the first die 28a can include two separate cavities 42 with a thermal mass 19, such as a steel plate 45, mounted on each side 31 of each cavity and a thermal mass 19, such as a steel plate 55, mounted along the base 29 of each cavity. In another embodiment, as illustrated in FIG. 4, the first die 28a can include one cavity 42 with a thermal mass 19, such as a steel plate 45, mounted on each side 31 of the cavity and a thermal mass 19, such as a steel plate 55, mounted along the base 29 of the cavity. As illustrated in FIG. 3, the second die 28b can include two protuberances 40 with a thermal mass 19, such as a steel plate 65, mounted along the base 29 of each protuberance. The steel plates 45, 55, 65 can be secured to the respective side 31 or base 29 using suitable mechanical fasteners 47, such as bolts or screws. In another embodiment (not shown), thermal masses 19 may also be provided along the sides of the second die 28b. For embodiments in which the dies 28a, b are more shallow no thermal masses 19 may be required along the sides 31 of either the first or second dies. While the thermal masses 19 are shown mounted along the bases 29 and sides 31 in the drawings, in another embodiment (not shown) the thermal masses can be mounted in the interior of a respective die, such as in the interior of a protuberance 40.

The number and dimensions of the thermal masses 19 mounted along the base 29 of each die 28a, b depends upon the width and length of the dies and the thickness t of the dies at the respective base 29, as illustrated in FIG. 4. Similarly, the number and dimensions of the thermal masses 19 mounted along the sides 31 of each die 28a, b, if any, depends upon the depth d of the dies, the thickness of the die wall, and the number and dimensions of any protuberances 40 within the die cavity 42. For example, referring to FIG. 4, for a die 28a having a cavity 42 approximately 205 mm wide and 313 mm long at the mouth 42a of the cavity and approximately 85 mm deep, the thermal masses 19 along the sides 31 comprise steel plates 45 that are approximately 70 mm wide, 340 mm long and 10 mm thick and the thermal mass 19 along the base 29 comprises a steel plate 55 that is approximately 245 mm wide, 340 mm long and 10 mm thick.

The apparatus 26 includes one or more radio-frequency “RF” induction coil 36 mounted to at least one of the first and second dies 28a, b. The apparatus also includes one or more power sources 35 in electrical communication with the RF induction coils 36, such as through suitable wiring 37, to supply radio-frequency energy to the coils. Advantageously, the RF induction coils are adapted to induce an electromagnetic field within at least one thermal mass 19 mounted to a respective die 28a, b to thereby quickly and efficiently heat the die through conduction and thermoform the fibrous slurry 30 into an article of fiber packaging. As noted above, each thermal mass 19 is preferably formed of a ferrous metal or alloy, so that the RF induction coils 36 will induce the requisite electromagnetic field within the thermal mass. Conversely, the first and second dies 28a, b are preferably formed of a non-ferrous material so that the RF induction coils 36 will not induce an electromagnetic field within the dies. In another embodiment, one or both of the first and second dies 28a, b can be formed of a ferrous metal or alloy so that the respective die comprises a thermal mass 19.

According to one embodiment, as illustrated in FIGS. 3 and 4, the first die 28a has a series of RF induction coils 36 mounted on each side 31 and along the base 29 of the die 28a and the second die 28b has a series of RF induction coils 36 mounted along the base 29. The number of RF induction coils 36 along the base 29 of each die 28a, b depends upon the width and length of the dies and the thickness t of the dies at the respective base 29. Similarly, the number of RF induction coils 36 along the sides 31 of each die 28a, b, if any, depends upon the depth d of the dies, the thickness of the die wall, and the number and dimensions of any protuberances 40 within the die cavity 42. For deep dies 28a, b, such as the dies shown in FIGS. 3 and 4, a series of RF induction coils 36 is required along the respective bases 29 of the first and second dies and circumferentially about the sides 31 of the first die 28a to adequately heat the dies. In another embodiment (not shown), RF induction coils may also be provided along the sides of the second die 28b. For embodiments in which the dies 28a, b are more shallow, only one, and in some cases no RF induction coils 36 may be required along the sides 31 of either the first or second dies. While the RF induction coils 36 are shown mounted along the bases 29 and sides 31 in the drawings, in another embodiment (not shown) the coils 36 can be mounted in the interior of a respective die, such as in the interior of a protuberance 40.

In conventional forming machines, expansion of the heating plates and dies due to non-uniform thermal gradients within the plates and dies adversely affected the tolerances of the fiber packaging. Consequently, the dies of conventional forming machines typically required a pre-heat period before the forming and drying operation could begin. Advantageously, because the thermal gradient within the first and second dies 28a, b of the present invention is relatively uniform, tool expansion will be about the center of the tool. Thus, the dies 28a, b can be set up cold thereby avoiding any lengthy start-up period.

The RF induction coils 36 can be made of a variety of materials, but are preferably constructed of one or more copper tubes 44. In one embodiment, the RF induction coils 36 are in fluid communication, such as through suitable piping, with a sump (not shown) of de-ionized water, which is pumped through the coils 36 to cool the coils and prevent any thermal damage. As illustrated in FIG. 4, the series of RF induction coils 36 mounted along the sides 31 of the first die 28a are at least partially and, preferably, are entirely encased in a shell of epoxy resin 38 to protect the coils from the ambient environment, which typically has a relatively high moisture content during operation of the forming apparatus 26. Such a “prepackaged” design for the RF induction coils 36 also facilitates replacement of a series of coils at one time thereby reducing the amount of time and labor required to service and maintain the apparatus 26 in comparison to conventional forming machines. The series of epoxy encased RF induction coils 36 are secured to the sides 31 of the first die 28a using suitable mechanical fasteners, such as bolts or screws. In one embodiment, as illustrated in FIG. 4, a layer of insulation 43 is positioned between the RF induction coils 36 and the respective thermal mass 19 mounted to the side 31 of the die 28a. In one embodiment, the insulation 43 is ceramic fiber.

As illustrated in FIG. 4, preferably the series of RF induction coils 36 mounted along the base 29 of the first die 28a are at least partially sandwiched between first and second layers of insulation 46a, b to protect the coils from the ambient environment. While insulation 46 can be provided between each coil in the series, preferably, a space or cavity 51 of air is provided between each coil. The insulation layers 46a, b and RF induction coils 36 are mounted to the base 29 of the die 28a against the steel plate 55 by a U-shaped retaining member 48. In one embodiment, the die includes flanges 50, each of which extends outwardly from a respective side 31. The U-shaped retaining member 48 is secured to the flanges 50 of the die 28a using suitable mechanical fasteners 52, such as bolts or screws. The U-shaped member 48 can be fabricated from a variety of materials, including a metal or metal alloy or a ceramic, but preferably is fabricated from aluminum or an aluminum alloy so that the RF induction coils 36 will not induce an electromagnetic field. In one embodiment, the insulation 46b is ceramic fiber. While the above discussion has been directed primarily to how the RF induction coils 36 are mounted to the first die 28a, the RF induction coils are mounted to the sides 31 and base 29 of the second die 28b in a similar fashion.

The specifications of the power source 35 depend upon the material used to construct the respective thermal mass 19 and the thickness of the fibrous slurry 30 that is being dried. For a thermal mass 19 constructed of mild steel, the power source for the RF induction coils 36 mounted along the base 29 of the dies is a 30 kW power source and the power source for the RF induction coils mounted along the sides 31 of the dies is a 20 kW power source. Preferably, the 20 kW and 30 kW power sources are Model Nos. Nova Star 20, L-20/150 or XP-30, which can be obtained from Ameritherm, Inc. of Scottsville, N.Y. The frequency of the radio-frequency energy supplied to the RF induction coils 36 by the power source also depends upon the material used to construct the respective thermal mass 19. For a thermal mass 19 constructed of mild steel, the power source preferably supplies RF energy at a frequency between approximately 90 to 110 kHz and, more preferably, at a frequency of 100 kHz.

As illustrated in FIG. 3, each die 28a, b preferably includes at least one sensor 54, such as a thermocouple, for measuring the temperature of the respective die. Advantageously, the sensor 54 measures the temperature of the respective die 28a, b rather than a heating plate adjacent to the die, as is typically done in conventional forming machines. Thus, according to the present invention, the temperature of the dies 28a, b can be more accurately controlled to thereby avoid any unnecessary power consumption. Preferably, the sensor 54 is in operable communication with the power source using suitable wiring so that the temperature of the respective die 28a, b can be automatically controlled by a processor, such as a computer or microprocessor, operating under software control.

As the radio-frequency energy is conducted through the RF induction coils, an electromagnetic field is induced within the respective thermal mass 19, thereby quickly and efficiently heating the die to a set point temperature between about 190 and 220° C. Advantageously, testing has revealed that the RF induction coils 36 of the improved forming apparatus 26 of the present invention reduce power consumption for heating the dies 28a, b by approximately 50%, increase the efficiency of the forming apparatus 26, and decrease the cycle time of the forming apparatus by approximately 25 to 50%. Moreover, due to the significant reduction in the cycle time of the first and second dies 28a, b using the RF induction coils 36, it is possible to lower the target set point of the dies from approximately 300° C., as is required for conventional forming machines, to approximately 200° C. and still obtain the above noted decrease in cycle time.

The RF induction coils 36 of the present invention substantially improve efficiency and provide a significant reduction in the cycle time for drying the fibrous slurry. Advantageously, unlike conventional forming machines where heat must be supplied to the heating plate continuously during the drying process, the power source 35 of the present invention can be switched on and off during operation of the apparatus 26 to thereby conserve power and further reduce the operating cost of the apparatus.

The present invention also includes a method of forming an article of fiber packaging from a fibrous slurry. In one embodiment, the method includes the steps of positioning a layer of slurry between first and second dies. Thereafter, radio-frequency energy is supplied to one or more induction coils mounted to at least one of the first and second dies to thereby heat the respective die and thermoform the fibrous slurry into the article of fiber packaging. In one embodiment, the method includes inducing an electromagnetic field in at least one thermal mass mounted to at least one of the first and second dies and then conducting heat from the at least one thermal mass to the respective die. The method preferably includes cooling the induction coil or coils with water. The temperature of the heated die can be measured and then modified by automatically adjusting the radio-frequency energy supplied to the induction coil or coils. The method can include moving the first die towards the second die before the supplying step to press the slurry therebetween and moving the first die away from the second die after the supplying step so that the article of fiber packaging can be removed from the dies.

In another embodiment, according to the present invention, the method of forming an article of fiber packaging from a fibrous slurry includes positioning a layer of slurry between first and second dies and then inducing an electromagnetic field within at least one thermal mass mounted to at least one of the first and second dies using radio-frequency energy to thereby heat the respective die and thermoform the fibrous slurry into the article of fiber packaging. The temperature in the heated die can be measured and then modified by automatically adjusting the electromagnetic field within the at least one thermal mass to thereby modify the temperature of the die. The method can include moving the first die towards the second die before the supplying step to press the slurry therebetween and moving the first die away from the second die after the supplying step so that the article of fiber packaging can be removed from the dies.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for thermoforming an article of fiber packaging from a fibrous slurry, comprising:
first and second co-operable dies being adapted to receive the fibrous slurry therebetween;
at least one thermal mass being mounted to at least one of said first and second dies;
at least one radio-frequency induction coil being mounted to at least one of said first and second dies; and
at least one power source being in electrical communication with said at least one radio-frequency induction coil to supply radio-frequency energy thereto and wherein said at least one radio-frequency induction coil is adapted to induce an electromagnetic field within said at least one thermal mass to thereby heat said respective die and thermoform the fibrous slurry into the article of fiber packaging.

2. An apparatus according to claim 1 wherein said at least one radio-frequency induction coil comprises:
at least one copper tube; and
an epoxy shell at least partially encasing said at least one copper tube.

3. An apparatus according to claim 2 wherein said at least one radio-frequency induction coil is water-cooled.

4. An apparatus according to claim 1 wherein at least one of said first and second dies comprises at least one sensor for measuring the temperature of said respective die, said sensor being in operable communication with said power source for automatically controlling the temperature of said respective die.

5. An apparatus according to claim 1 wherein each of said first and second dies defines a base and a pair of sides, said at least one thermal mass being mounted to one of said bases of said respective die, and said at least one radio-frequency induction coil being mounted to one of said bases of said respective die.

6. An apparatus according to claim 1 wherein each of said first and second dies defines a base and a pair of sides, said at least one thermal mass being mounted to one of said sides of said respective die, and said at least one radio-frequency induction coil being mounted to one of said sides of said respective die.

7. An apparatus according to claim 1 further comprising a member for moving said first die towards and away from said second die.

8. An apparatus according to claim 1 wherein said first and second dies are formed of aluminum.

9. An apparatus according to claim 1 wherein said at least one thermal mass comprises a steel plate.

10. An apparatus according to claim 9 wherein said energy source supplies radio-frequency energy at between approximately 90 to 110 kHz.

11. An apparatus for thermoforming an article of fiber packaging from a fibrous slurry, comprising:
a forming station; and
at least one press station, comprising:
first and second co-operable dies being adapted to receive the fibrous slurry therebetween;
at least one thermal mass being mounted to at least one of said first and second dies;
at least one radio-frequency induction coil being mounted to at least one of said first and second dies; and
at least one power source being in electrical communication with said at least one radio-frequency induction coil to supply radio-frequency energy thereto and wherein said at least one radio-frequency induction coil is adapted to induce an electromagnetic field within said respective at least one thermal mass to thereby heat said respective die and thermoform the fibrous slurry into the article of fiber packaging.

12. An apparatus according to claim 11 wherein said at least one radio-frequency induction coil comprises:
at least one copper tube; and
an epoxy shell at least partially encasing said at least one copper tube.

13. An apparatus according to claim 12 wherein said at least one radio-frequency induction coil is water-cooled.

14. An apparatus according to claim 11 wherein at least one of said first and second dies comprises at least one sensor for measuring the temperature of said respective die, said sensor being in operable communication with said power source for automatically controlling the temperature of said respective die.

15. An apparatus according to claim 11 wherein each of said first and second dies defines a base and a pair of sides, said at least one thermal mass being mounted to one of said bases of said respective die, said at least one radio-frequency induction coil being mounted to one of said bases of said respective die.

16. An apparatus according to claim 11 wherein each of said first and second dies defines a base and a pair of sides, said at least one thermal mass being mounted to one of said sides of said respective die, and said at least one radio-frequency induction coil being mounted to one of said sides of said respective die.

17. An apparatus according to claim 11 further comprising a member for moving said first die towards and away from said second die.

18. An apparatus according to claim 11 wherein said first and second dies are formed of aluminum.

19. An apparatus according to claim 11 wherein said at least one thermal mass comprises a steel plate.

20. An apparatus according to claim 19 wherein said energy source supplies radio-frequency energy at between approximately 90 to 110 kHz.

21. A method of forming an article of fiber packaging from a fibrous slurry, comprising:
positioning a layer of slurry between first and second dies; and
supplying radio-frequency energy to at least one induction coil mounted to at least one of the first and second dies to thereby heat the respective die and thermoform the fibrous slurry into the article of fiber packaging.

22. A method of forming an article of fiber packaging as defined in claim 21 further comprising:
inducing an electromagnetic field in at least one thermal mass mounted to at least one of the first and second dies; and
conducting heat from the at least one thermal mass to the respective die.

23. A method of forming an article of fiber packaging as defined in claim 21 further comprising cooling the at least one induction coil with water.

24. A method of forming an article of fiber packaging as defined in claim 21 further comprising:
measuring the temperature of the heated die; and
automatically adjusting the radio-frequency energy supplied to the at least one induction coil to thereby modify the temperature of the respective die.

25. A method of forming an article of fiber packaging as defined in claim 21 further comprising:
moving the first die towards the second die before said supplying step; and
moving the first die away from the second die after said supplying step.

26. A method of forming an article of fiber packaging from a fibrous slurry, comprising:
positioning a layer of slurry between first and second dies; and
inducing an electromagnetic field within at least one thermal mass mounted to at least one of the first and second dies using radio-frequency energy to thereby heat the respective die and thermoform the fibrous slurry into the article of fiber packaging.

27. A method of forming an article of fiber packaging as defined in claim 26 further comprising:
measuring the temperature of the heated die; and
automatically adjusting the electromagnetic field within the at least one thermal mass to thereby modify the temperature of the respective die.

28. A method of forming an article of fiber packaging as defined in claim 26 further comprising:
moving the first die towards the second die before said supplying step; and
moving the first die away from the second die after said supplying step.
